(19) United States
(12) Patent Application Publication
(10) Pub. No.: US 2014/0065029 A1
(43) Pub. Date: Mar. 6, 2014

(54) SYMMETRICAL REACTOR INCLUDING A PLURALITY OF PACKED TUBES

(71) Applicants: David B. Heinrich, Houston, TX (US); W. Blake Hendrix, Houston, TX (US); Jon M. Bill, Houston, TX (US); Kevin J. Drumm, Houston, TX (US)

(72) Inventors: David B. Heinrich, Houston, TX (US); W. Blake Hendrix, Houston, TX (US); Jon M. Bill, Houston, TX (US); Kevin J. Drumm, Houston, TX (US)

(73) Assignee: DYNAMIC ENGINEERING INC., Houston, TX (US)

(21) Appl. No.: 13/596,587

(22) Filed: Aug. 28, 2012

(51) Int. Cl. B01J 19/24

(52) U.S. Cl. CPC B01J 19/2415
USPC 422/201; 422/129; 422/228; 422/310

(57) ABSTRACT

A reactor having a top to bottom design configuration capable of being operated in an up flow or down flow configuration with equal ease, where the reactor includes a plurality of tubes optionally housed within a shell and includes top and bottom screen assemblies capable of retaining a catalyst within the tubes, while permitting reactants and products to flow through them.

### BACKGROUND OF THE INVENTION

1. Field of the Invention

Embodiments of the present invention relate to a tube and shell reactor design capable of being operated in an up flow or down flow configuration.

More particularly, embodiments of the present invention relate to a tube and shell reactor design capable of being operated in an up flow or down flow configuration, where the reactor includes a plurality of tubes arranged within a shell so that the tubes may be heated or cooled as required for the purpose of controlling the temperature of materials that are contained within the tubes; furthermore, the reactor components include a top and bottom screen capable of retaining a catalyst within the tubes while permitting reactants and products to flow through them.

2. Description of the Related Art

Various reactor systems for use in catalytic reactions, especially reactors using resin bead based catalysts have been proposed, built and used, but all have certain draw backs.

There remains a need in the art for reactors that are economical; simple to build, operate, and maintain; and that may be changed from up flow to down flow without having to modify the reactor or replace components.

### SUMMARY OF THE INVENTION

### Reactors

Embodiments of this present invention relate to reactors for performing chemical reactions equally well in an up flow or a down flow orientation and are capable of routine flow reversals without modification, a capability which may have utility, for example, for the purpose of regenerating catalyst particles, or dislodging catalyst particles from filters thereby extending the service life of the filters. This design will avoid premature replacement of catalyst or replacement of filters avoiding untimely shutdown of the process.

Tube and Shell Core

The reactors include a tube and shell core having a top, a bottom, a plurality of tubes designed to contain a catalyst and a closed shell surrounding the tubes. The shell includes inlets and outlets for circulating a heat transfer fluid through the shell for either heating or cooling the tubes. The core end flanges each incorporate a recess between the sealing surface of the flange and the ends of the tubes, where the ends of the tubes terminate in a planar arrangement that either protrudes into the recess or simply ends flush with the bottom of the recesses. Each core end flange incorporates a lip that includes a plurality of fastener apertures.

Screens

The reactors also include screens that are assembled with screen flanges, where both screens and screen flanges are substantially the same for both ends of the reactor. The screens are comprised of geometrical elements having a narrow or pointed side and a polygonal flat side. The geometrical elements are arrayed so their flat sides describe a plane and gaps between adjacent elements are smaller than the smallest diameter of the catalyst particles. The screens are designed for assembly into the reactor so that the flat sides of the geometrical elements face the tube openings and thereby prevent passage of catalyst from the core into the head assemblies. In certain embodiments, the flat sides of the geometrical elements are installed flush or substantially flush with the ends of the tubes in the core. In other embodiments, the flat sides of the geometrical elements are spaced away from the tube ends to thereby create a lateral flow annular gap for reduced restriction entering or exiting the tubes.

Screen Flanges

The reactors also include screen flanges for holding the upper and lower screens, where the screen flanges are configured for each to be captured within recesses of either or both of the head flanges and reactor flanges during the process of assembling the respective head onto the core within the recesses of either or both of the head flanges and reactor flanges.

Head Assemblies

The reactor also includes head assemblies that are designed with head flange details that can be the same for both heads. Each head assembly also includes a flange that incorporates a lip having a plurality of fasteners apertures which register with the fastener apertures in the lip of a core flange so that the head assemblies may be mounted on the top and bottom of the reactor core. The head assemblies also include straight sections and domed sections. The domed section for each head assembly includes a port disposed substantially at the center, where a reactant stream can be fed into the port of the first head assembly and a product stream can then be withdrawn from the port of the second head assembly. The head assemblies also each include a baffle element for distributing the flow of the incoming reactant stream across the screen surface, the flow then passing through the screen and into the tubes. In certain embodiments, the baffle elements are designed to form a substantially uniform flow of reactants across the screen surface.

Gaskets

The reactors also include gaskets that are disposed between the core end flange sealing surface and the head assembly flange sealing surface so that when the head assemblies are mounted on the cores, the resulting couplings are fluid tight.

Catalyst Distribution with the Reactors

The reactor core of this invention is designed to operate with a catalyst retained therein by screens where the catalyst fills or substantially fills all tubes and all contiguous volumes bounded between the screens so that the resulting void volume is approximately equal to the void volume of close packed catalyst particles.

Operation

Flowing reactant is introduced to flow through the port of the first head, become distributed by the first baffle to flow across the first screen, flow through the first screen, flow through the catalyst behind the first screen, flow through the catalyst contained in the tubes, flow through the catalyst contained between the ends of the tubes and the second screen, flow through the second screen, and into the second head while leaving the catalyst behind, and then flow to exit through the port in the second head.

### Methods for Assembling the Reactors

Embodiments of this invention relate to methods for assembling the reactor of this invention including the steps required for inserting the screen.
1. First method relates to a reactor design incorporating corresponding recesses in both head flanges and core flanges that can secure the screens in place during assembly without the use of an assembly fixture. Screen and flange assemblies and gaskets are configured for secure gravity retention that will resist dislocation by ordinary side jostling at all stages of reactor assembly and bolt up. This method includes that the bottom head gasket is retained in place on the bottom head flange sealing surface during assembly by features of the screen flange which is itself securely located in a recess in the bottom head flange and that the top head gasket is retained in place on the core top end flange sealing surface during assembly by features of the gasket flange which is itself securely located in a recess in the top core end flange.
2. Second method relates to a reactor design incorporating a recess in either the head flange or core flange but not both, consequently either inbuilt features or auxiliary assembly fixtures may be required for the purpose of securing one or the other screen in place during assembly or disassembly. This method includes that one screen, say the bottom screen, will be securely located by benefit of geometric features, say by a recess in the bottom head flange, during assembly and disassembly whereas the other screen, in this case the top screen, will rest on a flat and featureless surface of the tube and shell flange during assembly and disassembly thereby being at risk of being inadvertently bumped or pushed off location and thereby jamming assembly attempts unless either an inbuilt feature or auxiliary assembly fixture is utilized for securing it. Alternately, providing a recess in the core top flange for locating the screen but not in the head flange will result in the need for either an inbuilt or an auxiliary assembly fixture for the bottom screen.

The methods also include disposing a bottom gasket on the bottom head assembly flange sealing surface, mounting the bottom head assembly onto the core bottom so the apertures in the lips register, inserting fasteners into the apertures, and securing the bottom assembly to the bottom of the core so that the bottom assembly flange sealing surface, the bottom gasket, and the bottom core flange sealing surface form a first fluid tight coupling and the bottom screen is captured in place.

The methods also include filling the reactor from the top with a catalyst, where the amount of catalyst is sufficient to fill the total volumetric capacity of the reactor contained between the catalyst retention faces of the two screens with a resulting void volume that is approximately equal to the void volume of close packed catalyst particles.

The methods also include inserting a screen and flange assembly into the top recess of the core flange (or resting the screen and flange assembly atop the core flange if such a recess is not present). The methods also include disposing a top gasket atop the top core flange sealing surface, mounting the top head assembly onto the core top flange so the apertures in the lips register, inserting fasteners into the apertures, and securing the top assembly to the top of the core so that the top core flange sealing surface, the top gasket, and the top head assembly flange sealing surface form a top fluid tight coupling and captures the top screen in place. The screens and assemblies are substantially identical so that a flow through the reactor may enter from either end (that is, up-flow or down-flow in the case of a vertically oriented reactor) without modifying the reactor and the flow may be reversed by switching the flow direction without modifying the reactor.

### Methods for Using the Reactors

Embodiments of this present invention relate to a method for operating a reactor of this invention. The methods include the step of feeding a reactant stream into the inlet port of the top or bottom assembly. The methods also include intercepting the flow of the incoming reactant stream with a flow baffle element to disperse the reactant flow across the screen. In certain embodiments, the dispersed flow is uniform or substantially uniform across the screen so that each tube receives substantially the same reactant flow rate, where the term substantially here means that the flow rates through the tubes differ by no more that 20%; in some embodiments, no more than 15%; in other embodiments no more than 10%; and in yet other embodiments, no more that 5%. In certain embodiments, the flow rate of the reactant stream is sufficiently high so that the reactant flow through each tube is turbulent, thereby prompting or maximizing reactant and product mass transfer in or off the catalyst surfaces and/or into and out of the catalyst interior. In other embodiments, the flow rate may be adjusted so that the flow through the tube is laminar. In other embodiments, the flow rate may be variable. In all case, the flow of reactants through the tubes may be controlled by the reactant feed rate and the nature of the flow baffle element. The methods also include withdrawing a product stream from the outlet port of the other assembly. The methods may also include recycling a portion of the product stream. The methods may also periodically, semi-periodically, or intermittently reverse the flow of materials through the reactor in order to dislodge fugitive catalyst particles from the filters thereby possibly extending filter maintenance and/or filter replacement service intervals, regenerate catalyst, dislodge catalyst particles from the filters thereby potentially extending catalyst useable lifetimes and/or reduce catalyst regeneration cycle times. In certain embodiments, the flushing material may be the reactants used in the reaction or an inert stream. In other embodiments, periodic, semi-periodic, or intermittent flow reversal may be performed during normal operations by lowering the tube temperature below the reaction temperature and then reversing the flow again, raising the temperature of the tubes to reaction temperature and continuing the reaction.

### BRIEF DESCRIPTION OF THE DRAWINGS

The invention can be better understood with reference to the following detailed description together with the appended illustrative drawings in which like elements are numbered the same:

FIG. 1A depicts an embodiment of a top to bottom symmetric reactor of this invention.

FIG. 1B depicts an expanded sectional view through the reactor top at the section A-A showing a top of the reactor core of FIG. 1A.

FIG. 1C depicts an expanded sectional view through flow baffle at the section B-B of FIG. 1A.

FIG. 2A depicts a plan view of an embodiment of a screen of this invention having tetrahedral pyramidal elements.

FIG. 2B depicts a plan view of an embodiment of a screen of this invention having hexagonal pyramidal elements.

FIG. 2C depicts a plan view of an embodiment of a screen of this invention having star pyramidal elements.

FIG. 2D depicts a plan view of an embodiment of a screen of this invention having wedge profile linear elements.

FIG. 3A depicts a cross-sectional view of an embodiment of a screen and head assembly coupled to the core.

FIG. 3B depicts a cross-sectional view of another embodiment of a screen and head assembly coupled to the core.

FIG. 3C depicts a cross-sectional view of another embodiment of a screen and head assembly coupled to the core.

FIG. 3D depicts a cross-sectional view of another embodiment of a screen and head assembly coupled to the core.

FIG. 3E depicts a cross-sectional view of another embodiment of a screen and head assembly coupled to the core.

FIG. 3F depicts a cross-sectional view of another embodiment of a screen and head assembly coupled to the core.

FIG. 4A depicts an expanded sectional view of a top of another reactor core of this invention.

FIG. 4B depicts an expanded view of the core of FIG. 4A viewed along the sectional line A-A.

FIG. 5 depicts an expanded sectional view of a top of another reactor core of this invention.

FIGS. 6A&B depicts an embodiment of a screen flange of this invention shown in plan view and cross-sectional view along with radial dimensions.

FIGS. 7A&B depicts another embodiment of a screen flange of this invention shown in plan view and cross-sectional view along with radial dimensions.

FIG. 8A depicts a cross-sectional view of an illustrative embodiment of a first screen flange type of this invention with internal dimensions.

FIG. 8B depicts a cross-sectional view of the flange of FIG. 8A including a portion of the gasket 164, the screen 182, and an optional compressible component 802.

FIG. 9A depicts a cross-sectional view of an illustrative embodiment of a second screen flange type of this invention with internal dimensions.

FIG. 9B depicts a cross-sectional view of the flange of FIG. 9A including a portion of the gasket 164, the screen 182, and an optional compressible component 902.

FIG. 10A depicts a cross-sectional view of an illustrative embodiment of a third screen flange type of this invention with internal dimensions.

FIG. 10B depicts a cross-sectional view of the flange of FIG. 10A including a portion of the gasket 164, the screen 182, and an optional compressible component 1002.

FIG. 11 depicts a cross-sectional view of an expanded section of the reactor, where the end flange and the head assembly flange include a sacrificial coating or layer 1102 at the screen flange interface surfaces.

FIG. 12 depicts a cross-sectional view of an expanded section of the reactor, where the screen flange includes a sacrificial coating or layer 1202 at the end flange and head assembly flange interface surfaces.

FIG. 13 depicts a cross-sectional view of an expanded section of the reactor, where a sacrificial element 1302 is included at the screen flange and the end flange interface surfaces.

FIG. 14 depicts a cross-sectional view of an expanded section of the reactor, where a sacrificial element 1402 is included at the screen flange and the head flange interface surfaces.

### DETAILED DESCRIPTION OF THE INVENTION

The inventors have found that a tube and shell reactor can be constructed that has top to bottom symmetry so that the reactor is capable of being operated in an up flow configuration or down flow configuration without having to modify the reactor or elements of the reactor. The inventors have found that the top to bottom symmetry allows the reactant flow through the reactor to be reversed allowing filters and/or screens clearing of fugitive catalyst particles without disassembly or other disruptive operations. Reversing the flow permits the dislodging of fugitive particles from filters possibly extending filter maintenance and/or replacement service intervals thereby reducing the need for downtime resulting from actual filter maintenance

Embodiments of this invention broadly relate to top to bottom symmetric reactors for carrying out catalytic reactions. The reactors include a reactor core including a plurality of tubes and a surrounding shell. The core also includes a top flange with lip, a bottom flange with lip, a top recess and a bottom recess. Alternately, the flanges may be configured with or without recesses depending upon the configuration of the top and bottom head flanges. The lips include fastener apertures. The reactors also include a top and bottom head assembly that is mounted to the top and bottom of the core. The two head assemblies can be identical so that the final assembled reactor can be symmetrical top to bottom. The shell includes ports for circulating a cooling fluid or heating fluid into the reactor core for heating or cooling the tubes. In certain embodiments, the coolant is circulated through the shell in order to control temperatures within the tubes. The symmetric top/bottom reactor designs permit reactor operation in either an up-flow or down-flow configuration with equal ease, without having to change any reactor components. This design feature permits the reactant flow through the reactor to be reversed and dislodge fugitive particles from filters with the reversed flow possibly extending filter maintenance and/or filter replacement service intervals reducing the need for downtime resulting from actual filter maintenance. The top/bottom symmetric designs also permits interchangeability of screens, heads, gaskets, etc. of the top and bottom assemblies thereby streamlining installation because parts can generally be harmlessly interchanged. The interchangeability of parts also simplifies ordering and inventory control.

The top and bottom head assemblies include a flange with sealing surface and bolting lip, a straight section, and a domed section. The lips include fastener apertures, designed to register with the fastener apertures of the core flange lips. The domed section for each head includes a port for supplying (or withdrawing) reactants (product) into (out of) the reactor. The assemblies also include screen flanges with catalyst retention screens, and sealing gaskets. The screen flanges with catalyst retention screens are designed to be disposed into the recesses of the core flanges. The gaskets are designed to be disposed between the sealing surfaces of the head assembly flanges and the core flanges to form a fluid tight seal when fasteners are inserted into the lip fastener apertures and tightened. Each screen is designed to permit reactants and products to flow into and out of the reactor core and tubes while retaining the catalyst within. The screens are disposed so that the faces of the screens comprised of the flat sides of the screen elements are flush with the tubes; but, in some designs there is a gap between the faces of the screens and the tubes openings that provides a transverse flow area leading to the tube entrances for ensuring unobstructed inflow from all points in the neighborhood of the tube opening. The screen and reactor designs are compatible with tube configurations that either project beyond the surface of the core flange or are flush with it.

In the embodiment of the screens, the screens are formed of a pattern of geometrical elements having a sharp side when examined from one direction, say when viewed from above for a top screen, and a flat side when examined from the opposite direction, say when viewed from below for a top screen, where the geometrical elements are arrayed so their flat sides describe a plane and the gaps between the elements (element gaps) are at least 10% smaller than a smallest dimension of the catalyst particles. In other embodiments, the gaps between the elements are at least 20% smaller than the smallest dimension of the catalyst. In other embodiments, the gaps between the elements are at least 30% smaller than the smallest dimension of the catalyst. In other embodiments, the gaps between the elements are at least 40% smaller than the smallest dimension of the catalyst. In other embodiments, the gaps between the elements are at least 50% smaller than the smallest dimension of the catalyst. Each screen is structured with all the elements oriented with the flat sides facing in the same direction. The screens are then oriented with the flat sides of the elements oriented toward the tubes. The geometrical elements may be conical elements (cones), polygonal pyramidal elements, or wedge profile linear elements. Suitable polygonal pyramidal elements include regular polygonal pyramids and star shaped polygonal pyramids. Suitable regular polygonal pyramids include tetrahedra or distorted tetrahedra, square pyramids and distorted square pyramids, pentagonal pyramids and distorted pentagonal pyramids, hexagonal pyramids and distorted hexagonal pyramids, octagonal pyramids and distorted octagonal pyramids, higher order polygonal pyramids and distorted higher order polygonal pyramids, and suitable combinations thereof. Suitable wedge shapes include convex side, flat side, and concave side wedge shapes. The screens are designed to require no additional gaskets or fasteners as a screen is designed to be held with the screen flange which during assembly becomes captured within a recess located in either or both of the top and bottom flange of the reactor core and the top and bottom head assembly flange.

The reactors also include reactor flanges that are designed in concert with screen flange design(s) in order that both the flange gasket and screen are secure and aligned during handling, assembly, and disassembly. The reactors also include at least one flow baffle disposed near the inlet to disperse the inlet flow more or less uniformly across the tubes in order to maximize catalyst utilization. In certain embodiments, the flow baffle includes a perforated disk attached via welded legs inside each head a distance 6 from the inlet port. The baffles are designed to disperse the flow of incoming reactants and then distribute it across the first screen for a more or less even flow and pressure distribution across all tubes. Both head assemblies include a flow baffle so that the reactor may be easily switched between up flow and down flow operation.

### Illustrative Screen Assembly Embodiments

Embodiments of this invention relate also to screen assemblies including (a) screen flange and a screen, where the screen is adapted to be affixed to a screen shoulder of the flange. The affixing may be by, without limitation, welding such as spot welding, forge welding, TIG welding, MIG welding, etc., gluing, cold forging, hot forging, forging so that the screen and/or flange materials become deformed and the screen is retains due to the deformation, or any other similar method for affixing or secures the screen to the flange. In certain embodiments, the screen assembly may include a screen retaining member or ring that is placed on top of the screen after the screen is disposed on the flange and welded to the flange. In other embodiments, the screen assembly is of a unitary construction, where the circumference of the screen constitutes the flange. In other embodiments, the flange is molded or cast onto an outer edge of the screen to produce a unitary screen assembly.

### Illustrative Reactor Embodiments

Embodiments of this invention relate to reactors that include (a) a core, (b) two head assemblies, (c) two screen assemblies, and (d) a core flange recess and/or a head flange recess adapted to receive the screen assembly. The core includes: (1) a plurality of reactor tubes, each tube having a first tube end and a second tube end, (2) a first core end flange and a second core end flange, each end flange including a core sealing surface, (3) a pattern of tube apertures disposed in each flange for locating the reactor tubes, (4) a core flange lip having apertures there through, (5) a flange gasket, and (6) fasteners. Each head assembly includes: (1) a head flange including an assembly sealing surface, a head flange lip having a plurality of apertures therethrough, and an optional head flange recess, (2) a cap section including an inlet port and an outlet port for flowing a reactant into and out of the reactor, and (3) an interior. Each screen assembly includes: (1) a screen comprising a plurality of screen elements, and (2) a screen mounting flange characterized by an inside diameter, an outside diameter, a projected minor diameter, an overall thickness, and a shoulder height. The tubes are fixed in place within the tube apertures; the screen is or the screen elements are affixed to the screen flange to form the screen assembly; the gasket is interposed between the sealing surfaces; and the head assembly is seated on the core end flange so that the lip apertures of the core and the assembly are aligned and the fasteners are inserted through the lip apertures of the core and the assembly retains the gasket and screen assembly within and tightening the fasteners compresses the gasket creating a fluid tight seal between the core and the head assembly. The reactor design permits the reactor to be operated in a down flow arrangement or an up flow arrangement simply by changing a reactant flow direction due to a top to bottom symmetry of the reactor.

In certain embodiments, the reactor includes a core flange recess. In other embodiments, the reactor includes a head flange recess. In other embodiments, the screen flange outside diameter corresponds to and self locates within the screen flange recess of the core end flange, the screen flange projected minor diameter corresponds to and self locates within the screen flange recess of the head assembly. The gasket has an inside diameter that corresponds to and self locates on the screen flange projected diameter, a portion of the gasket material that extends inwardly beyond the sealing surface of the core end flange rests against the screen flange axial retention face, a shoulder created by the radial difference between the screen flange outside and projected diameter, and compresses when tightening the flange lip fasteners which presses the screen flange axially against the screen flange recess axial face thereby minimizing any gaps.

In other embodiments, the screen flange shoulder height corresponds to the depth of the screen flange recess of the core end flange. In other embodiments, the screen assembly is seated within the head assembly screen flange recess. In other embodiments, the gasket does not include a portion that extends past the sealing surface of core flange for pressing and holding the screen flange in axial contact, but includes a second compressible component for the purpose interposed between the screen flange and the core end flange. In other embodiments, the screen assembly further includes ribs for reinforcing, and/or for mounting, and unmounting the screen or screen assembly. In other embodiments, the ribs include holes, lugs, and/or flanges to assist screen handling. In other embodiments, the screen assembly is partially or wholly retained by a dowel assembly. In other embodiments, the reactor also further comprises top and bottom flow volumes are bounded between the screens and the tube ends and the ends of the core baffle, where the volumes are defined by a first gap height g between the screen flat ends and the tube ends and a second gap height r between the screen flat ends and the baffle tops, where the gaps g and r may be the same or different. In other embodiments, the reactor of claim further includes a catalyst loaded into the reactor in an amount sufficient to substantially fill the tubes and the flow volumes during normal reactor operation. In other embodiments, each head assembly further includes a flow baffle assembly mounted within the interior for distributing incoming reactant to the tubes of the reactor. In other embodiments, the flow baffles include flow pathways therethrough. In other embodiments, the reactor further includes a shell surrounding the tubes and including an interior, and shell ports for circulating a heating or cooling fluid through the interior of the shell.

In other embodiments, the tubes have a geometrical cross-section and are arranged in a tube pattern having a packing efficiency within an geometrical shell, where tube cross-section and the envelop cross-section geometrical shapes are selected from the group consisting of circular, elliptical, polygonal, and mixtures thereof.

### Illustrative Embodiments of Methods for Using the Reactors

Embodiments of this invention relate to method for using the reactor including the steps of providing a top to bottom reversible flow reactor of this invention. The methods also includes the steps of loading a catalyst into the reactor in an amount sufficient to substantially fill the tubes and the flow volumes and feeding a reactant stream into one of the ports of one of the head assemblies. The methods also include the steps of contacting the reactant with the catalyst in the tubes and the flow volumes, and withdrawing a product stream through one of the ports of the other head assembly. In other embodiments, the method further include the steps of stopping the reactant flow, and starting a flow of a reverse flow stream in an opposite flow direction to the reactant flow direction on an intermittent or periodic basis, where the reverse flow operates to clear the screens reducing maintenance In other embodiments, the methods further include the step of regenerating the catalyst during reverse flow, where the reverse flow stream is a catalyst regeneration stream and regeneration extends catalyst life. In other embodiments, the methods further includes the step of prior to the contacting step, distributing the reactant flow across the volumes and the tubes via a flow baffle to improve flow uniformity through the tubes.

### Illustrative Embodiments of Screen Assemblies

Embodiments of this invention relate to a screen assembly including a screen comprising a plurality of screen elements, and a screen mounting flange characterized by an inside diameter, an outside diameter, a projected minor diameter, an overall thickness, and a shoulder height, and a core flange recess and/or a head flange recess adapted to receive the screen assembly, where the screen is or the screen elements are affixed to the screen flange to form the screen assembly.

Illustrative Embodiments Including Sacrificial Components and/or Coatings

In certain embodiments, where the reactants supplied to and/or products generated in the reactor may include corrosive components, the reactor may include additional components and/or coatings that act as sacrificial corrosion sites. Such sacrificial components may be used in reactor applications prone to crevice corrosion such as that induced within small openings (crevices) where two metal surfaces come into close proximity or actual contact, including where the two metal surfaces are of metal having the same or substantially the same galvanic potential. The sacrificial components and/or coatings are generally constructed out of materials having a lower galvanic potential than the materials that are to be protected by the sacrificial components and/or coating. For example, if the tubes, core flanges and head flanges are made of stainless steel, then the screen flange may be made of a lower galvanic potential iron alloy so that corrosion preferentially affects the aforementioned iron alloy flanges. Alternatively, surfaces of the core flanges and/or the head flanges may be coated with a sacrificial coating. In another alternative, surfaces of the screen flange may be coated with a sacrificial coating. In yet another embodiment, a sacrificial component may be interposed between contacting surfaces or simply placed in the flow volumes provided that the component does not interfere with reactant or product flow. In yet another embodiment, the flow baffle may be made of a sacrificial material.

### Suitable Reagents, Materials, or Components

Suitable materials out of which the core flanges and tube may be constructed include, without limitation, iron and iron alloys. Exemplary iron alloys include, without limitation, Elinvar (nickel, chromium); Fernico (nickel, cobalt); ferroalloys such as ferroboron, ferrochrome, ferromagnesium, ferromanganese, ferromolybdenum, ferronickel, ferrophosphorus, ferrosilicon, ferrotitanium, and ferrovanadium; Invar (nickel); cast iron (carbon); pig iron (carbon); wrought iron (carbon); Kovar (nickel; cobalt); Spiegeleisen (manganese; carbon; silicon); steel; bulat steel, Chromoly (chromium; molybdenum); crucible steel; Damascus steel; high speed steel; Mushet steel; HSLA steel; Maraging steel; Reynolds 531; silicon steel (silicon); spring steel; stainless steel (chromium, nickel) such as AL-6XN, Alloy 20, celestrium, marine grade stainless, martensitic stainless steel, surgical stainless steel (chromium, molybdenum; nickel), and Zeron 100 (chromium, nickel, molybdenum); tool steel (tungsten or manganese); silver steel (US:Drill rod) (manganese, chromium, silicon); Wootz steel; or mixtures and combinations thereof.

### DETAILED DESCRIPTION OF THE DRAWINGS

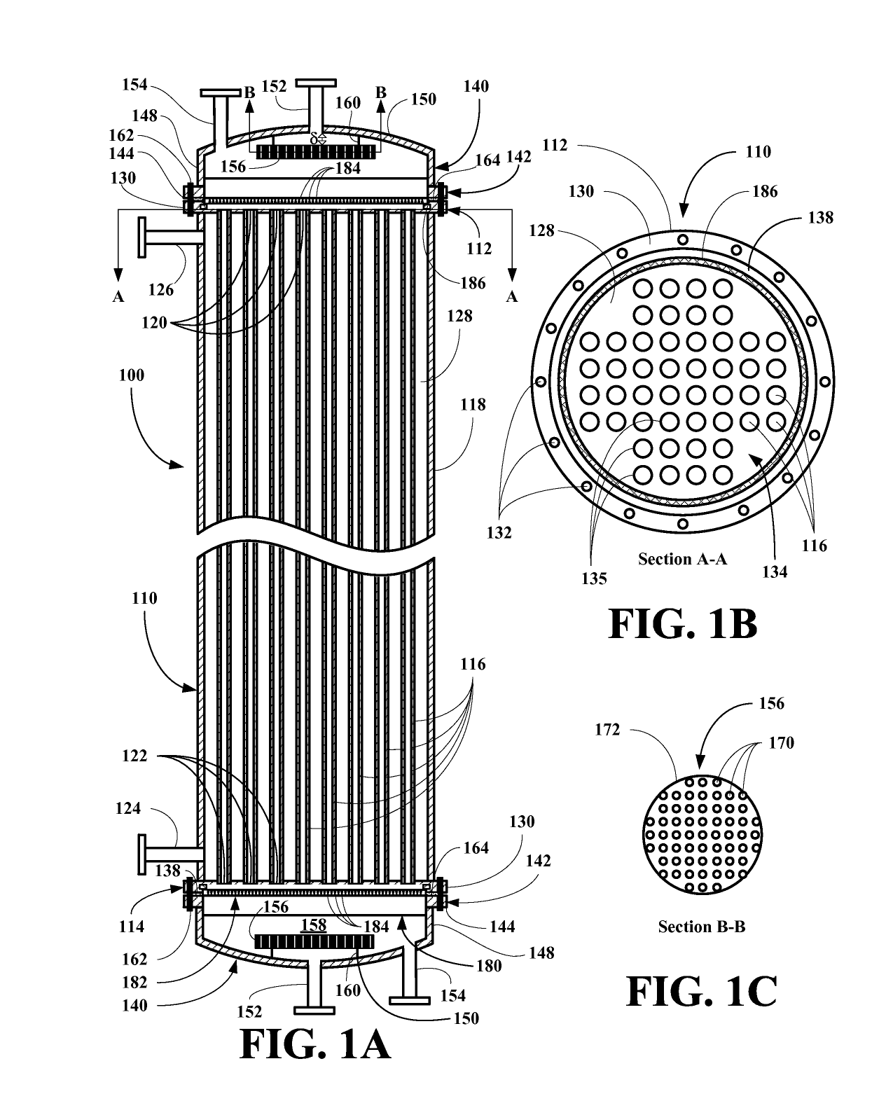

Referring now to FIG. 1A, an embodiment of an end-to-end top to bottom symmetric reactor of this invention, generally 100, is shown to include the following:

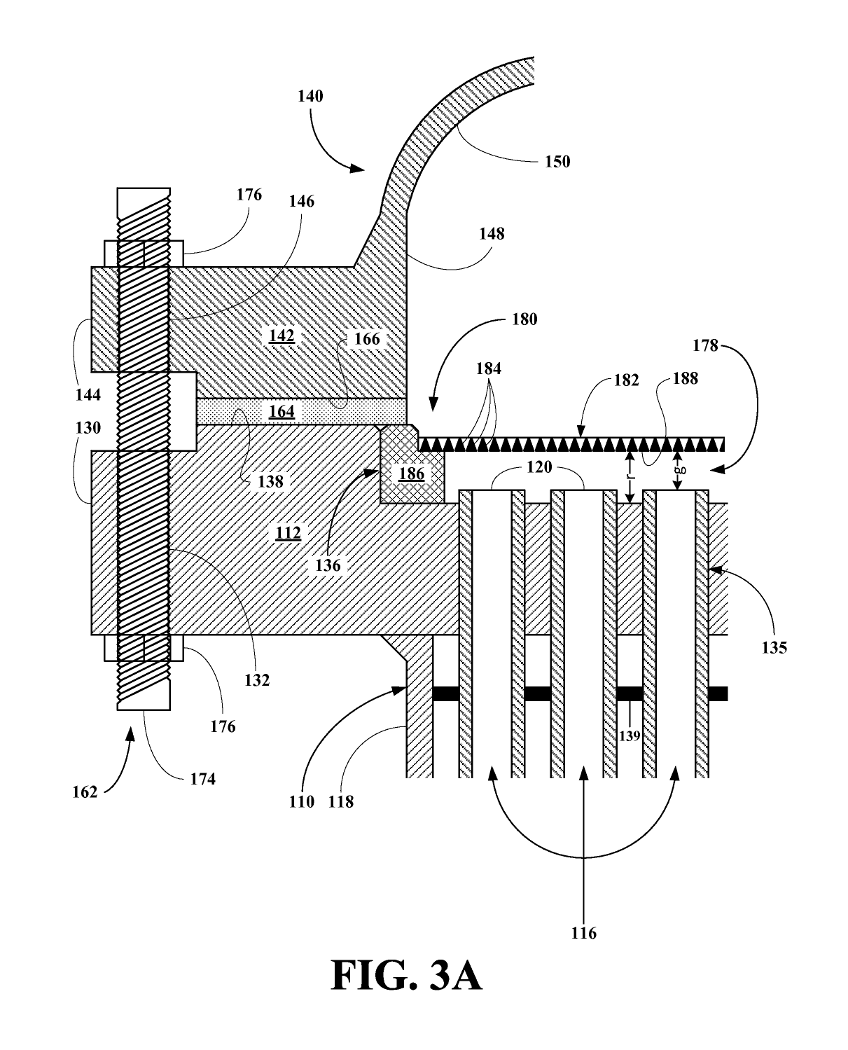

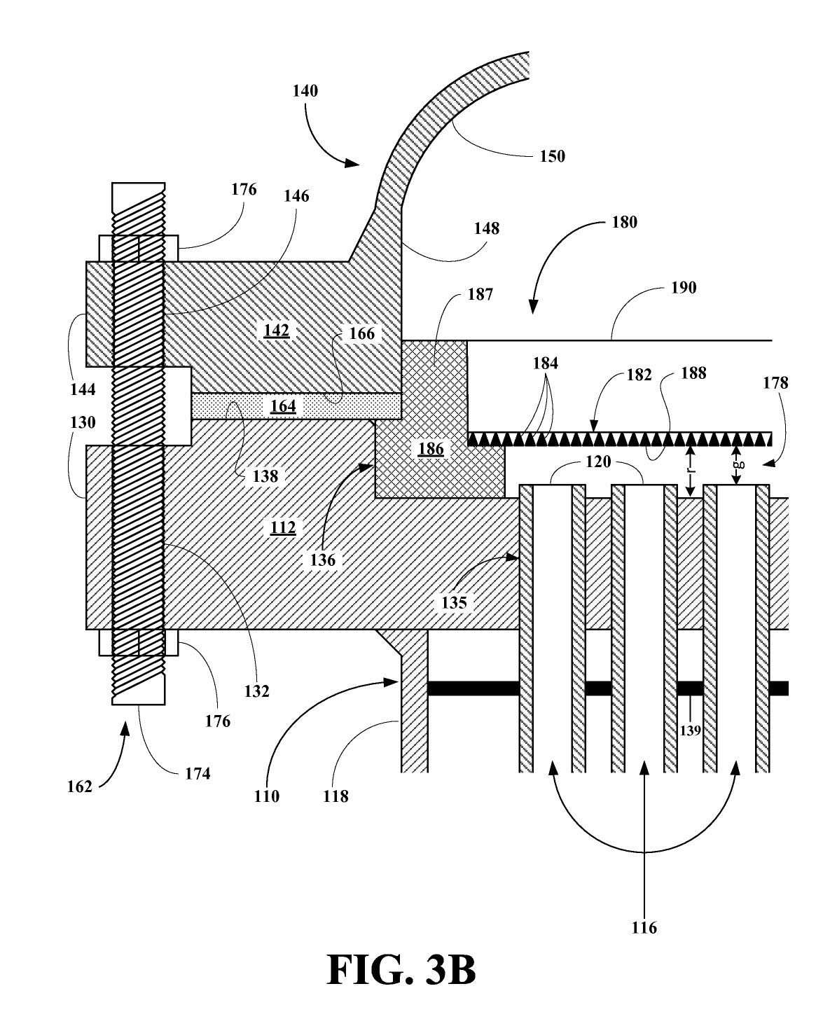

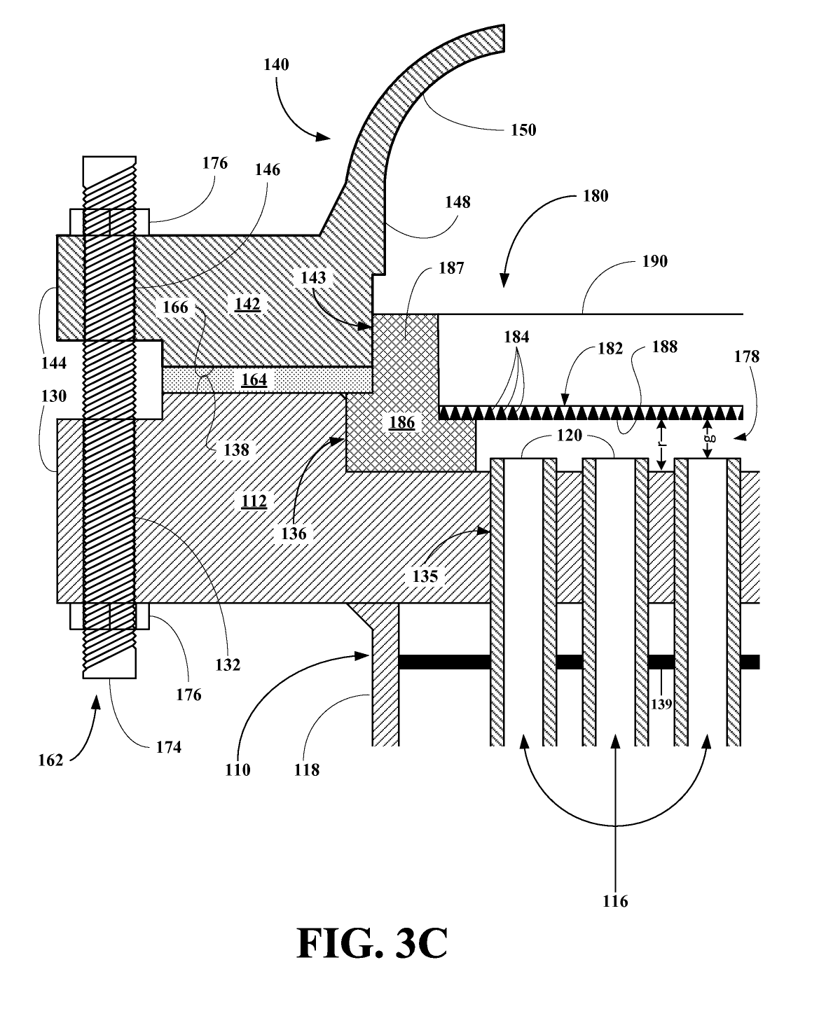

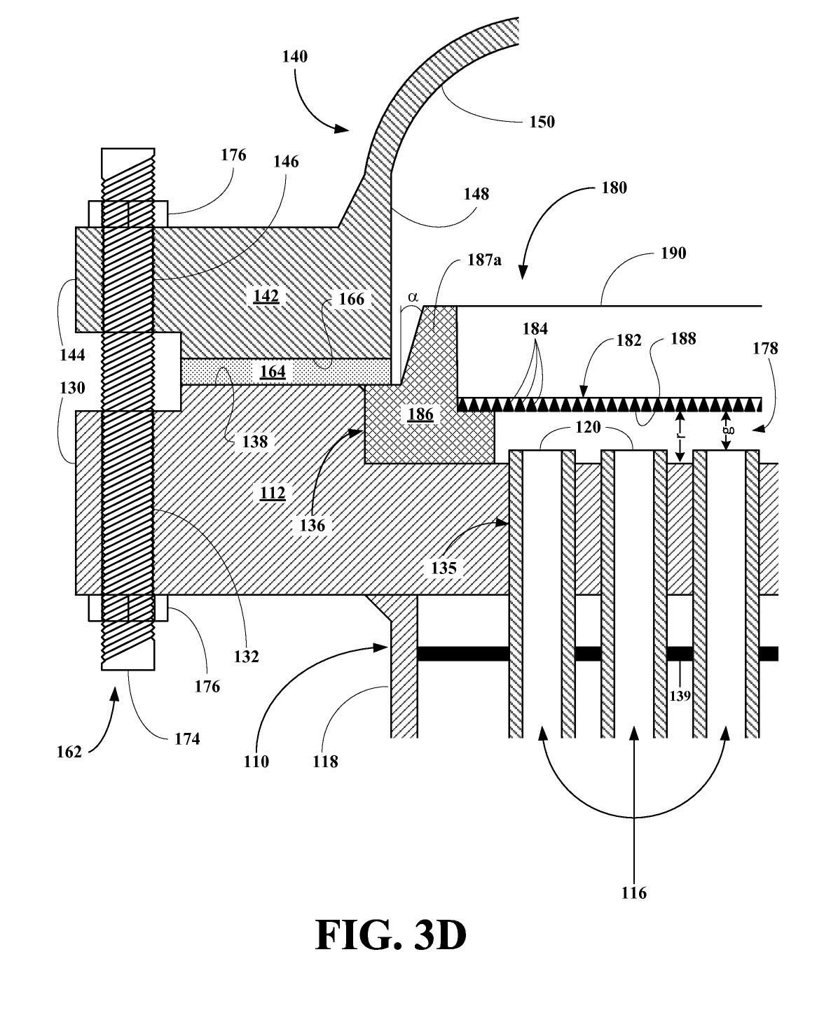

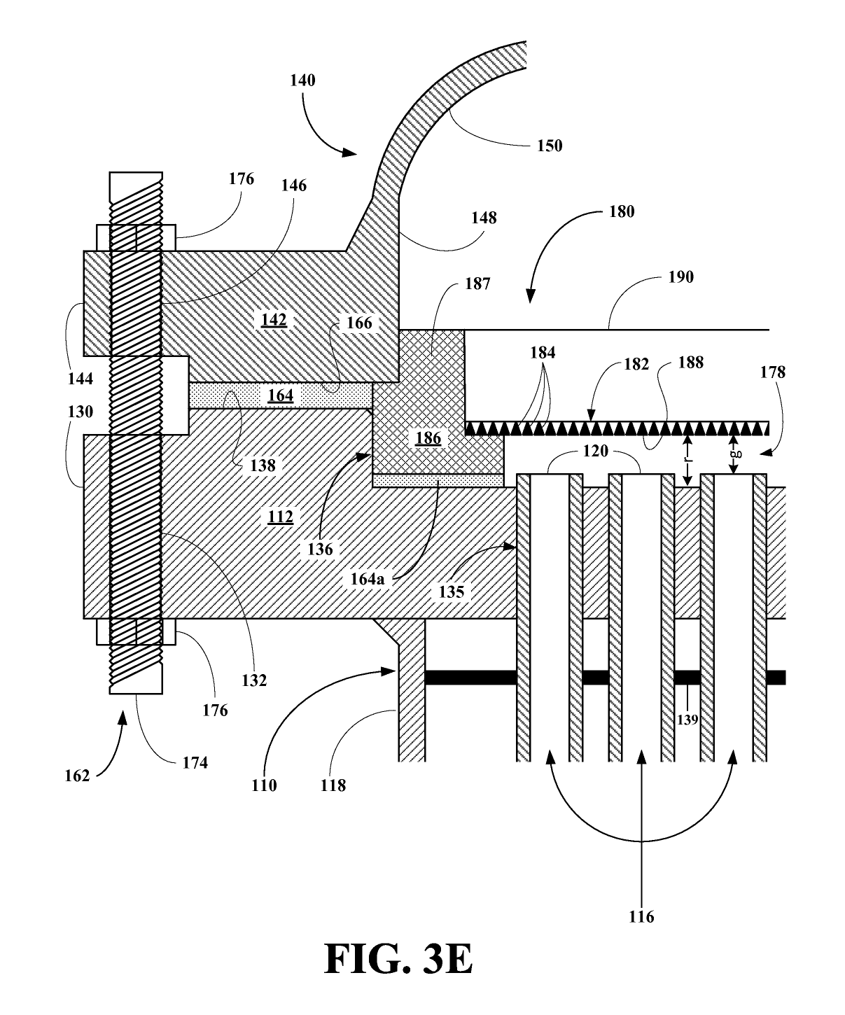

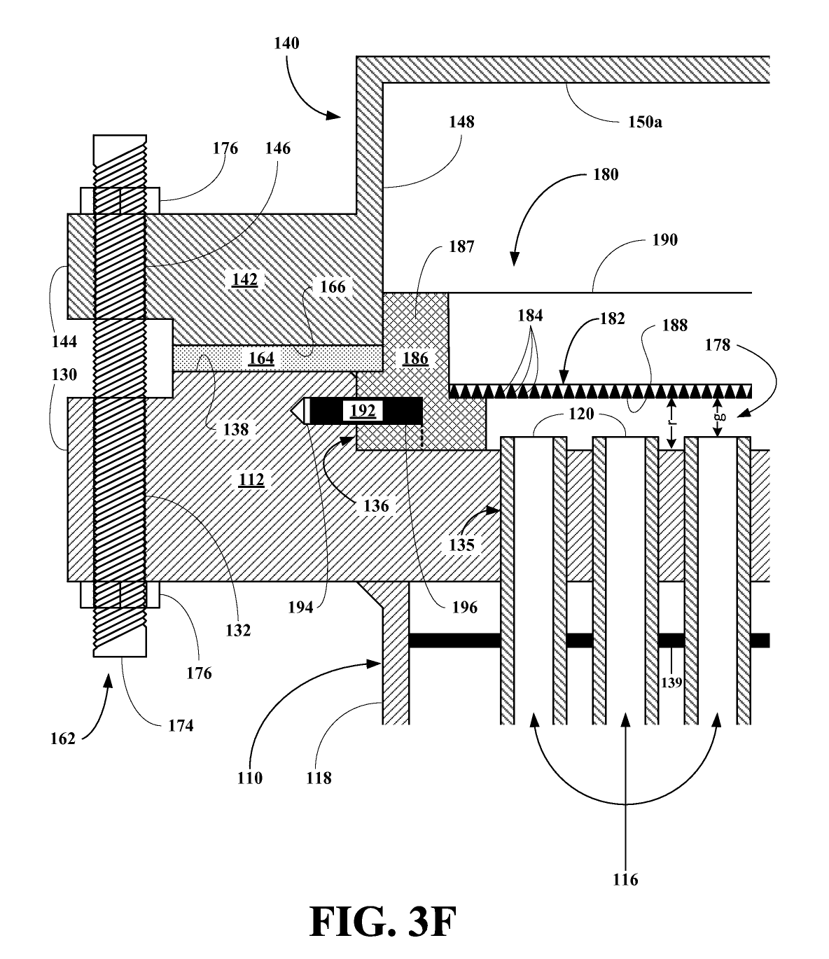

The core 110 includes a first end flange 112, a second end flange 114, a plurality of reaction tubes 116, and a shell 118 surrounding the tubes 116. Each tube 116 includes a first end 120 and second end 122. The shell 118 includes a first port 124 and a second port 126 for circulating a heating fluid or cooling fluid through an interior 128 of the shell 118 for heating and/or cooling the tubes 116. The first end flange 112 and the second end flange 114 of the core 110. The flanges 112 and 114 include lips 130 and fastener apertures 132 therethrough. The tubes 116 are arranged in a pattern 134 as shown in FIG. 1B. The flanges 112 and 114 also include a recess 136 (as shown in FIGS. 3A-C) for receiving a screen flange 186 and a core sealing surface 138.

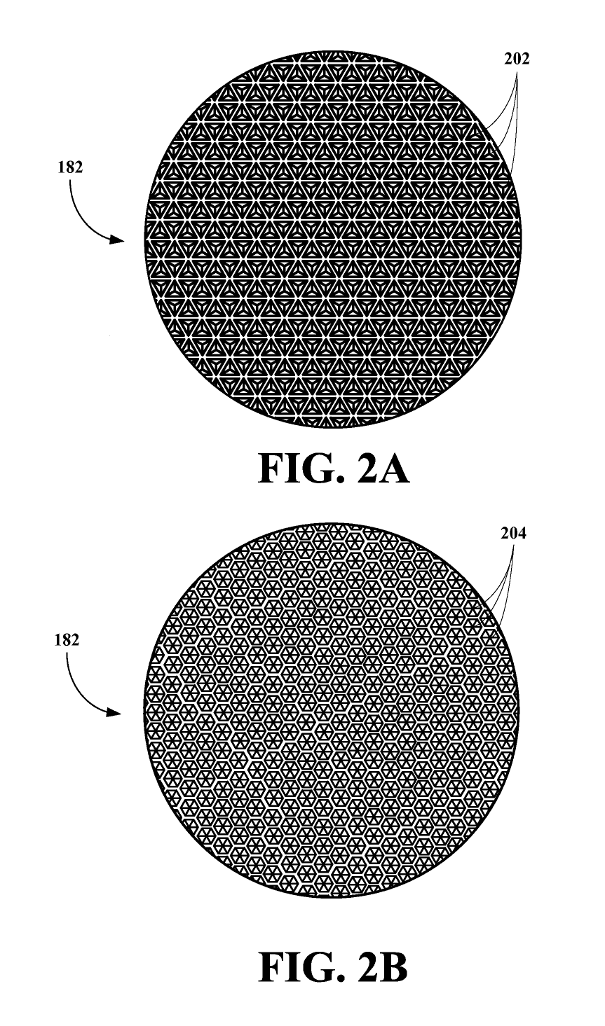

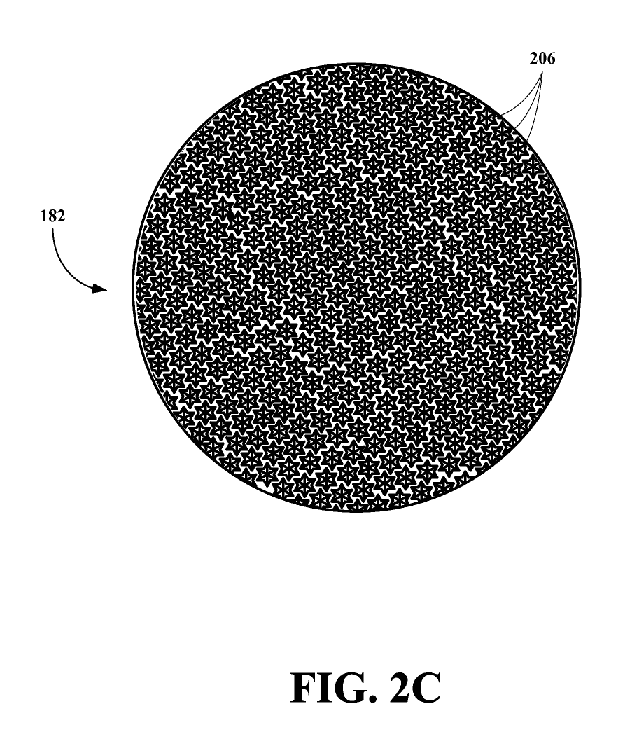

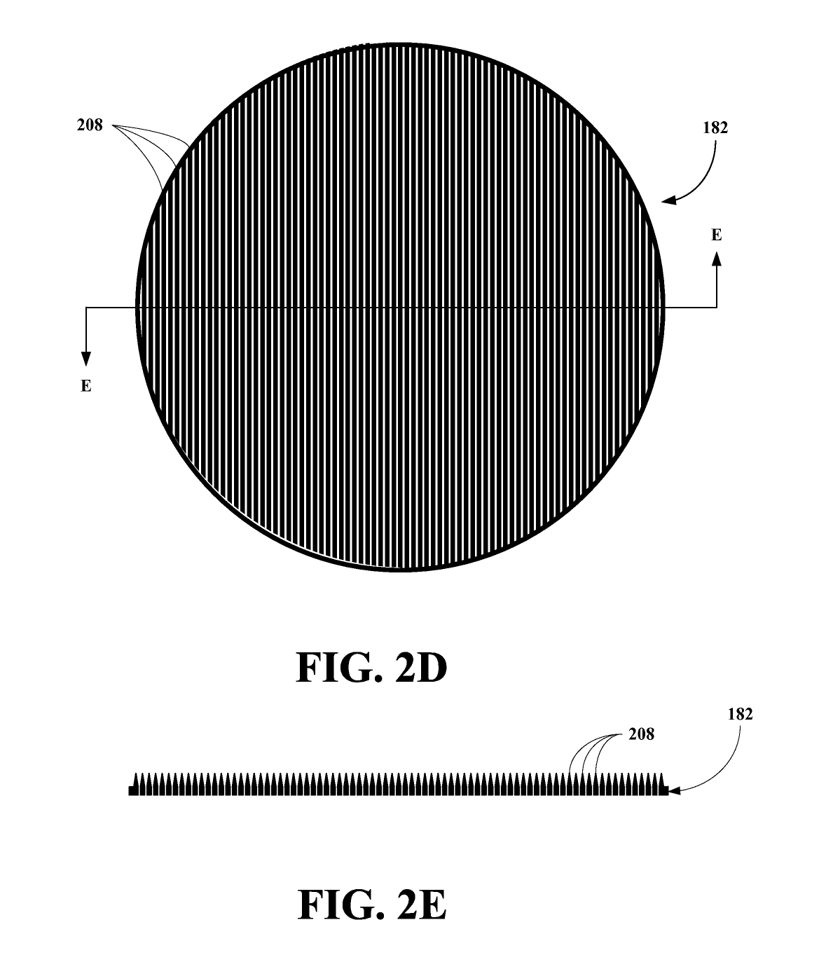

The reactor 100 also includes a first head assembly and a second head assembly, both designated 140. Each head assembly 140 includes a head assembly flange 142, which includes a lip 144 having fastener apertures 146 (shown in FIG. 3A-F). Each assembly 140 also includes a straight section 148 and a domed section 150. Each assembly 140 also includes two ports 152 and 154. Each assembly 140 also includes a flow baffle 156 disposed within an interior 158 of the head assemblies 140 a distance 6 from the port 152 and affixed within via struts 160. The head assemblies 140 are fastened to the core 110 via fasteners 162 inserted through the apertures 132 and 146 (as shown in FIGS. 3A-C), which affixes each head assembly 140 to the core 110. The reactor 100 also includes a gasket 164 interposed between the core sealing surface 138 and an assembly sealing surface 166 (as shown in FIGS. 3A-F). Each head assembly 140 also includes a screen assembly 180 including a screen 182 having screen elements 184 shown in greater detail in FIGS. 2A-D. The screen assembly 180 also includes a screen flange 186 shown in greater detail in FIGS. 1B and 3A-C.

Referring now to FIG. 1B, the Section A-A of the first end flange 112 of the reactor core 110 is shown to include an embodiment of a pattern 134 of tube apertures 135 adapted to receive the tubes 116, which are surrounded by the shell 118. The first end flange 112 also is shown to include the lip 130, the fastener apertures 132, and the core sealing surface 138.

Referring now to FIG. 1C, an embodiment of the flow baffle 156 is shown to include flow pathways 170 through the baffle 156 so that the reactant flow is dispersed through the pathways 170 and over an edge 172 of the baffle 156 to produce a more uniform distribution of reactants flow into the tubes 116.

Referring now to FIG. 2A, an embodiment of a screen 182 including a plurality of tetrahedral elements 202 arranged so that the gaps between the elements is less than the largest dimension of the catalysts, but not so small as to produce back pressure to the flow of reactants or products through the screen 182 sufficient to inhibit successful reactor operation. The screen elements 202 may be supported by providing a wire grid upon which the elements 202 are affixed; provided, of course, that the grid does not interfere with fluid flow through the screen 182. Alternately, the elements 202 may be welded at contact points between them, again provided that the welds do not interfere with fluid flow through the screen 182.

Referring now to FIG. 2B, another embodiment of a screen 182 including a plurality of hexagon pyramidal elements 204 arranged so that the gaps between the elements is less than the largest dimension of the catalysts, but not so small as to produce back pressure to the flow of reactants or products through the screen 182 sufficient to inhibit successful reactor operation. The screen elements 204 may be supported by providing a wire grid upon which the elements 204 are affixed; provided, of course, that the grid does not interfere with fluid flow through the screen 182. Alternately, the elements 204 may be welded at contact points between them, again provided that the welds do not interfere with fluid flow through the screen 182.

Referring now to FIG. 2C, another embodiment of a screen 182 including a plurality of star pyramidal elements 206 arranged so that the gaps between the elements is less than the largest dimension of the catalysts, but not so small as to produce back pressure to the flow of reactants or products through the screen 182 sufficient to inhibit successful reactor operation. The screen elements 206 may be supported by providing a wire grid upon which the elements 206 are affixed; provided, of course, that the grid does not interfere with fluid flow through the screen 182. Alternately, the elements 206 may be welded at contact points, again provided that the welds do not interfere with fluid flow through the screen 182.

Referring now to FIGS. 2D&E, a plan view and sectional view through section E-E of another embodiment of a screen 182 including a plurality of wedge elements 208 arranged so that the gaps between the elements is less than the largest dimension of the catalysts, but not so small as to produce back pressure to the flow of reactants or products through the screen 182 sufficient to inhibit successful reactor operation.

Referring now to FIG. 3A, a sectional view of an embodiment of the core 110, the head assembly 140, and the screen assembly 180 is shown assembled. The core 110 is shown to include tubes 116 disposed in the corresponding tube apertures 135 and the surrounding shell 118. The core 110 also includes shell baffles 139. The head assembly 140 is shown to include the straight section 148 and the domed section 150. The head assembly 140 is also shown to include the flange 142, the lip 144 and the fastener apertures 146. The assembly 140 is also shown to include the reaction tubes 116 and the shell 118 surrounding the tubes 116. The screen assembly 180 is shown to include the screen 182 having generic elements 184, where the flat surfaces of the generic elements 184 define a lower surface 188. The screen 182 is mounted on an embodiment of the screen flange 186 that is disposed in a recess 136 of the core top flange 112. The screen flange 186 is generally L-shaped. Each head assembly 140 is also shown to include a gasket 164 disposed between the core sealing surface 138 and the head assembly sealing surface 166 to form a fluid tight seal between the head assemblies 140 and the core 110. The fasteners 162 are shown here to be threaded bolts 174 and nuts 176. The assembled core 110, the head assembly 140, and the screen assembly 180 defining a head flow volume 178 between a lower surface 188 of the screen 182 and the tops 120 of the tubes 116 and the core top 112. The volume 178 is characterized by a first gap height g between the tops 120 of the tubes 116 and the lower surface 188 of the screen 182 and by a second gap height r between the core top 112 and the lower surface 188 of the screen 182. A value of the first gap height g ranges between about 0.25″ and 5″ and a value of the second gap height r ranges between about 0.25″ and about 8″.

Referring now to FIG. 3B, a sectional view of another embodiment of the core 110, the head assembly 140, and the screen assembly 180 is shown assembled. The core 110 is shown to include tubes 116 disposed in the corresponding tube apertures 135 and the surrounding shell 118. The core 110 also includes baffles 139. The head assembly 140 is shown to include the straight section 148 and the domed section 150. The head assembly 140 is also shown to include the flange 142, the lip 144, and the fastener apertures 146. The screen assembly 180 is shown to include the screen 182 having generic elements 184 and ribs 190 for reinforcement and easy installation of the screen 182. The screen 182 is mounted on an embodiment of the screen flange 186 that is disposed in a recess 136 of the end flange 112. The screen flange 186 for the embodiment exemplified in FIG. 3B is generally L-shaped having an extending part or projecting member 187 or is generally in an inverted T-shape. Each head assembly 140 is also shown to include a gasket 164 disposed between the core sealing surface 138 and the head assembly sealing surface 166 to form a fluid tight seal between the head assemblies 140 and the core 110. The fasteners 162 are shown here to be threaded bolts 174 and nuts 176. The assembled core 110, the head assembly 140, and the screen assembly 180 defining a head flow volume 178 between a lower surface 188 of the screen 182 and the tops 120 of the tubes 116 and the core top 112. The volume 178 is characterized by a first gap height g between the tops 120 of the tubes 116 and the lower surface 188 of the screen 182 and by a second gap height r between the core top 112 and the lower surface 188 of the screen 182. A value of the first gap height g ranges between about 0.25″ and 5″ and a value of the second gap height r ranges between about 0.25″ and about 8″.

Referring now to FIG. 3C, a sectional view of another embodiment of the core 110, the head assembly 140, and the screen assembly 180 is shown assembled. The core 110 is shown to include tubes 116 disposed in the corresponding tube apertures 135 and the surrounding shell 118. The core 110 also includes baffles 139. The head assembly 140 is shown to include the straight section 148 and the domed section 150. The head assembly 140 is also shown to include the flange 142 having a head flange recess 143, the lip 144, and the fastener apertures 146. The screen assembly 180 is shown to include the screen 182 having generic elements 184 and ribs 190 for reinforcement and easy installation of the screen 182. The screen 182 is mounted on an embodiment of the screen flange 186 that is disposed in a recess 136 of the end flange 112. The screen flange 186 for the embodiment exemplified in FIG. 3C is generally L-shaped having an extending part or projecting member 187 or is generally in an inverted T-shape. Each head assembly 140 is also shown to include a gasket 164 disposed between the core sealing surface 138 and the head assembly sealing surface 166 to form a fluid tight seal between the head assemblies 140 and the core 110. The fasteners 162 are shown here to be threaded bolts 174 and nuts 176. The assembled core 110, the head assembly 140, and the screen assembly 180 defining a head flow volume 178 between a lower surface 188 of the screen 182 and the tops 120 of the tubes 116 and the core top 112. The volume 178 is characterized by a first gap height g between the tops 120 of the tubes 116 and the lower surface 188 of the screen 182 and by a second gap height r between the core top 112 and the lower surface 188 of the screen 182. A value of the first gap height g ranges between about 0.25″ and 5″ and a value of the second gap height r ranges between about 0.25″ and about 8″.

Referring now to FIG. 3D, a sectional view of another embodiment of the core 110, the head assembly 140, and the screen assembly 180 is shown assembled. The core 110 is shown to include tubes 116 disposed in the corresponding tube apertures 135 and the surrounding shell 118. The core 110 also includes baffles 139. The head assembly 140 is shown to include the straight section 148 and the domed section 150. The head assembly 140 is also shown to include the flange 142, the lip 144, and the fastener apertures 146. The screen assembly 180 is shown to include the screen 182 having generic elements 184 and ribs 190 for reinforcement and easy installation of the screen 182. The screen 182 is mounted on an embodiment of the screen flange 186 that is disposed in a recess 136 of the end flange 112. The screen flange 186 for the embodiment exemplified in FIG. 3D is generally L-shaped having an angled extending part or angled projecting member 187a making an angle with the vertical of ? or is generally in an inverted T-shape. Each head assembly 140 is also shown to include a gasket 164 disposed between the core sealing surface 138 and the head assembly sealing surface 166 to form a fluid tight seal between the head assemblies 140 and the core 110. The fasteners 162 are shown here to be threaded bolts 174 and nuts 176. The assembled core 110, the head assembly 140, and the screen assembly 180 defining a head flow volume 178 between a lower surface 188 of the screen 182 and the tops 120 of the tubes 116 and the core top 112. The volume 178 is characterized by a first gap height g between the tops 120 of the tubes 116 and the lower surface 188 of the screen 182 and by a second gap height r between the core top 112 and the lower surface 188 of the screen 182. A value of the first gap height g ranges between about 0.25″ and 5″ and a value of the second gap height r ranges between about 0.25″ and about 8″.

Referring now to FIG. 3E, a sectional view of another embodiment of the core 110, the head assembly 140, and the screen assembly 180 is shown assembled. The core 110 is shown to include tubes 116 disposed in the corresponding tube apertures 135 and the surrounding shell 118. The core 110 also includes baffles 139. The head assembly 140 is shown to include the straight section 148 and the domed section 150. The head assembly 140 is also shown to include the flange 142, the lip 144, and the fastener apertures 146. The screen assembly 180 is shown to include the screen 182 having generic elements 184 and ribs 190 for reinforcement and easy installation of the screen 182. The screen 182 is mounted on an embodiment of the screen flange 186 that is disposed in a recess 136 of the end flange 112. The screen flange 186 for the embodiment exemplified in FIG. 3C is generally L-shaped having an extending part or projecting member 187 or is generally in an inverted T-shape. In this embodiment, the gasket 164 does not contact a surface of the flange 186. To allow for compression of the gasket 164 during assembly and tightening of fasteners 162, this screen assembly includes a second gasket 164a interposed between the second gasket 164a and the end flange 112. Each head assembly 140 is also shown to include a gasket 164 disposed between the core sealing surface 138 and the head assembly sealing surface 166 to form a fluid tight seal between the head assemblies 140 and the core 110. The fasteners 162 are shown here to be threaded bolts 174 and nuts 176. The assembled core 110, the head assembly 140, and the screen assembly 180 defining a head flow volume 178 between a lower surface 188 of the screen 182 and the tops 120 of the tubes 116 and the core top 112. The volume 178 is characterized by a first gap height g between the tops 120 of the tubes 116 and the lower surface 188 of the screen 182 and by a second gap height r between the core top 112 and the lower surface 188 of the screen 182. A value of the first gap height g ranges between about 0.25″ and 5″ and a value of the second gap height r ranges between about 0.25″ and about 8″.

Referring now to FIG. 3F, a sectional view of another embodiment of the core 110, the head assembly 140, and the screen assembly 180 is shown assembled. The core 110 is shown to include tubes 116 disposed in the corresponding tube apertures 135 and the surrounding shell 118. The core 110 also includes baffles 139. The head assembly 140 is shown to include the straight section 148 and a flat section 150a. The head assembly 140 is also shown to include the flange 142, the lip 144 and the fastener apertures 146. The screen assembly 180 is shown to include the screen 182 having generic elements 184 and ribs 190 for reinforcement and easy installation of the screen 182. The screen 182 is mounted on an embodiment of the screen flange 186 that is disposed in a recess 136 of the end flange 112. The screen flange 186 for the embodiment exemplified in FIG. 3D is generally L-shaped having an extending part or projecting member 187 or is generally in an inverted T-shape. The screen assembly 180 is also shown to include a dowel 192, a first dowel well 194 in the end flange 112 of core 110 and a second dowel well 196 in the screen flange 186. The dowel well of either the end flange of the core or the screen flange has an axial slot for bayonet-style pin and slot securing of the screen flange by partial turn of the screen flange during assembly or disassembly. Each head assembly 140 is also shown to include a gasket 164 disposed between the core sealing surface 138 and the head assembly sealing surface 166 to form a fluid tight seal between the head assemblies 140 and the core 110. The fasteners 162 are shown here to be threaded bolts 174 and nuts 176. The assembled core 110, the head assembly 140, and the screen assembly 180 defining a head flow volume 178 between a lower surface 188 of the screen 182 and the tops 120 of the tubes 116 and the core top 112. The volume 178 is characterized by a first gap height g between the tops 120 of the tubes 116 and the lower surface 188 of the screen 182 and by a second gap height r between the core top 112 and the lower surface 188 of the screen 182. A value of the first gap height g ranges between about 0.25″ and 5″ and a value of the second gap height r ranges between about 0.25″ and about 8″.

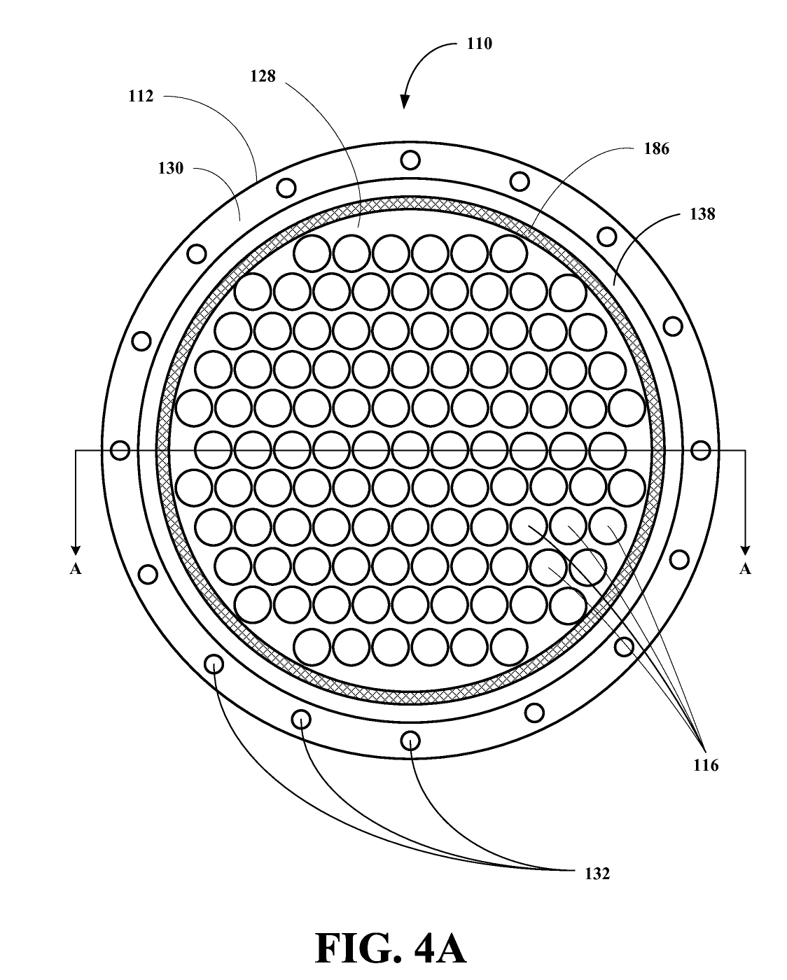

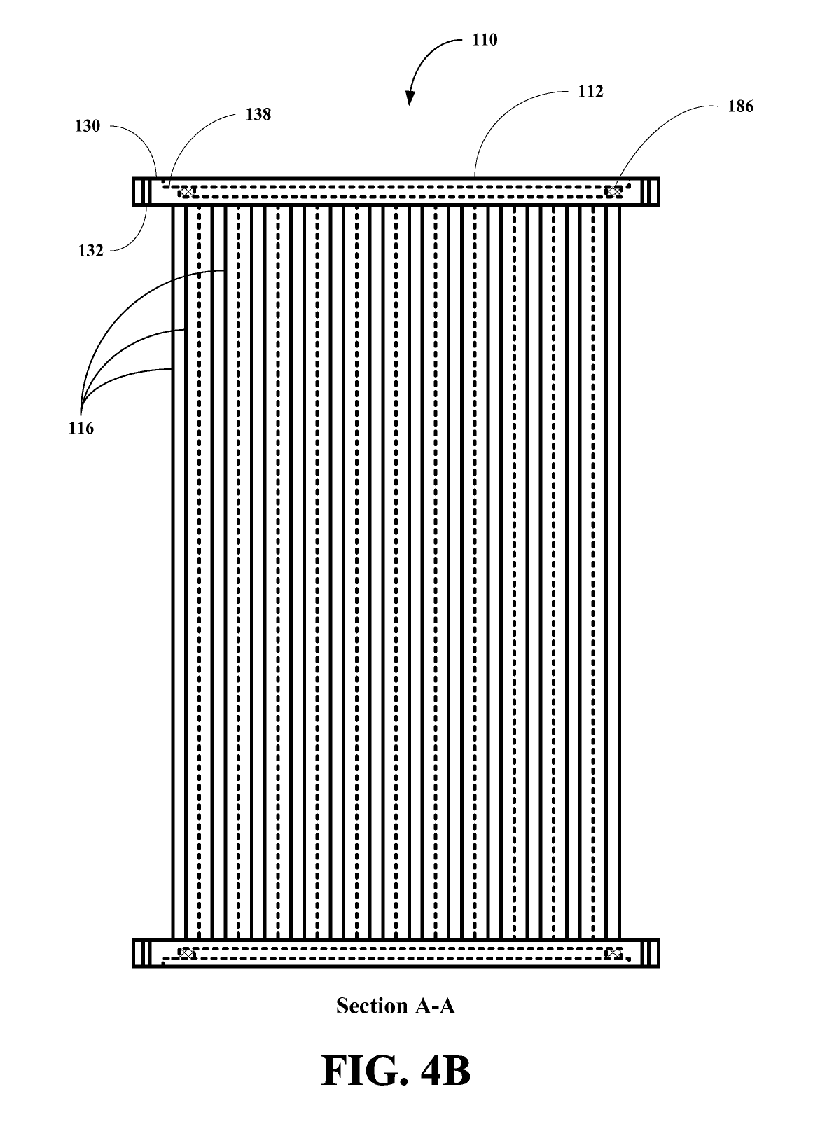

Referring now to FIGS. 4A&B, a top plan view of another cylindrical embodiment of the core 110 is shown to include the first end flange 112, a plurality of closely packed circular tube apertures 135, cylindrical tubes 116 disposed therein, the lip 130, the fastener apertures 132, and the first end flange sealing surface 138. The closely packed tube 116 may be used with or without a shell. In embodiments without a shell, the closely packed tube configuration helps the tubes 116 maintain a fairly uniform temperature, where fairly means than the tube to tube temperature difference is less than or equal to about 50° C. In other embodiments, the tube to tube temperature difference is less than or equal to 25° C.

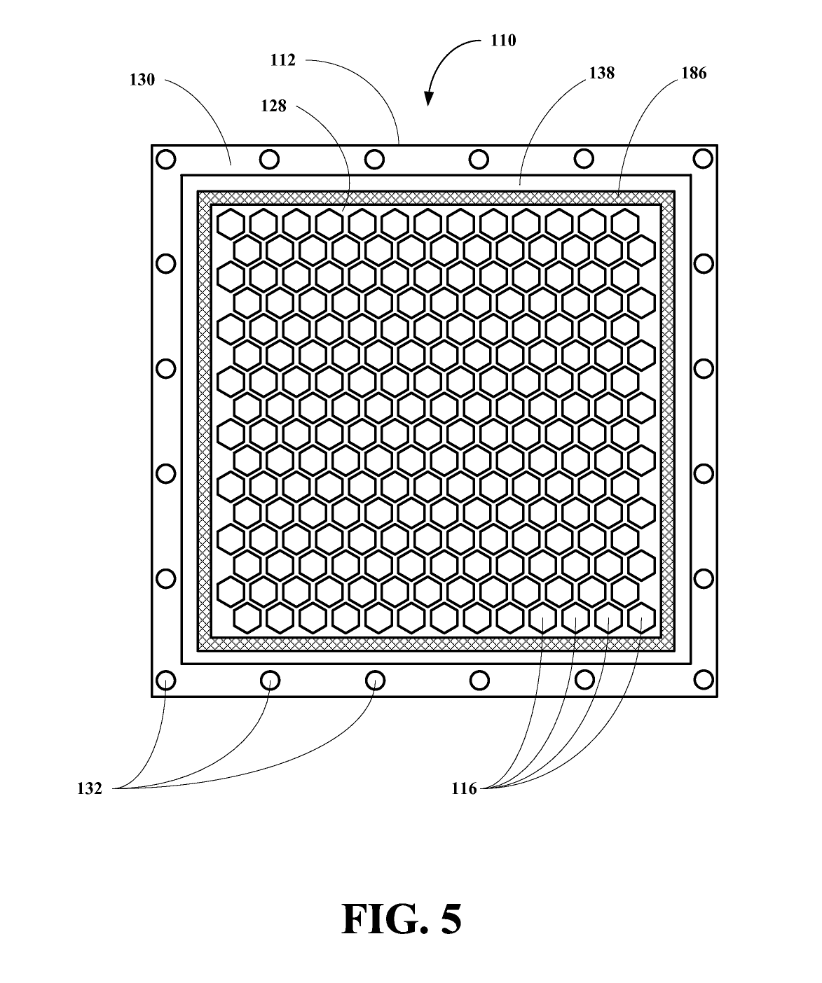

Referring now to FIG. 5, a top plan view of a rectangular/square embodiment of the core 110 is shown to include the first end flange 112, a plurality of closely packed hexagonal tube apertures 135, hexagonal tubes 116 disposed therein, the lip 130, the fastener apertures 132, and the first end flange sealing surface 138. The closely packed hexagonal tube 116 may be used with or without a shell. In embodiments without a shell, the closely packed hexagonal tube configuration helps the tubes 116 maintain a fairly uniform temperature, where fairly means that the tube to tube temperature difference is less than or equal to about 50° C. In other embodiments, the tube to tube temperature difference is less than or equal to 25° C.

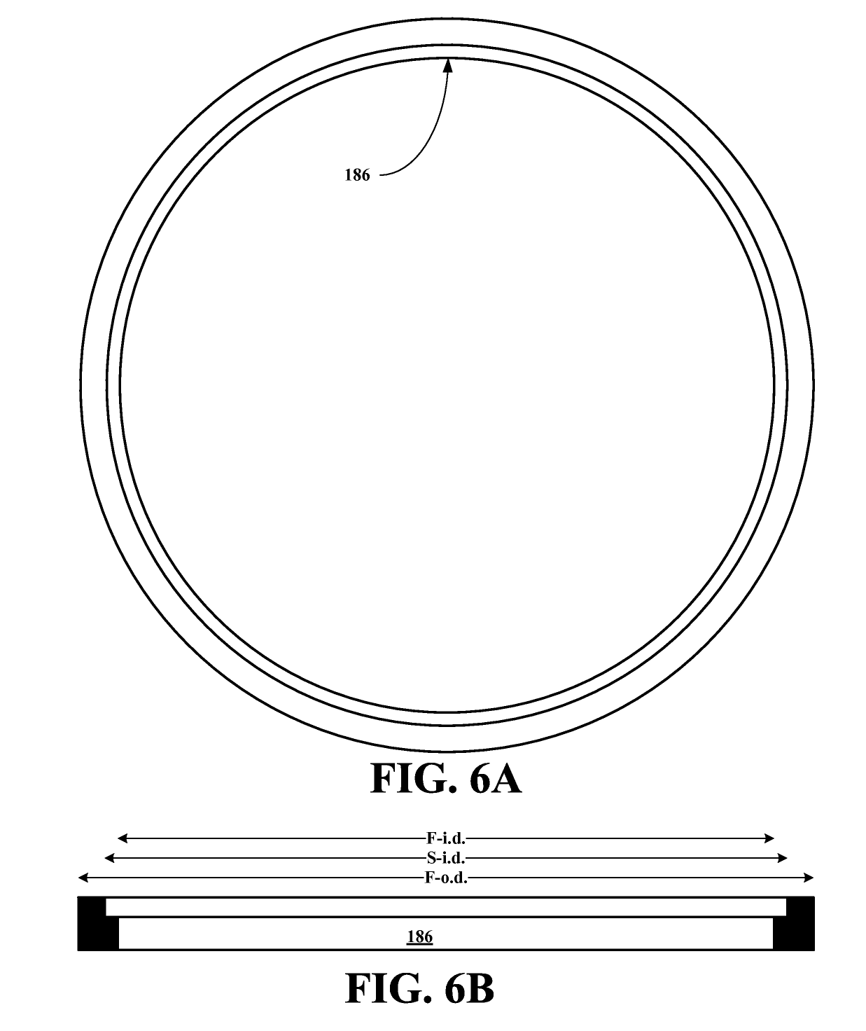

Referring now to FIGS. 6A&B, an embodiment of an L-shaped screen flange 186 shown plan and cross-sectional views. The flange 186 has a flange outer diameter F-o.d., a flange inner diameter F-i.d., and a radial screen indentation diameter S-i.d.

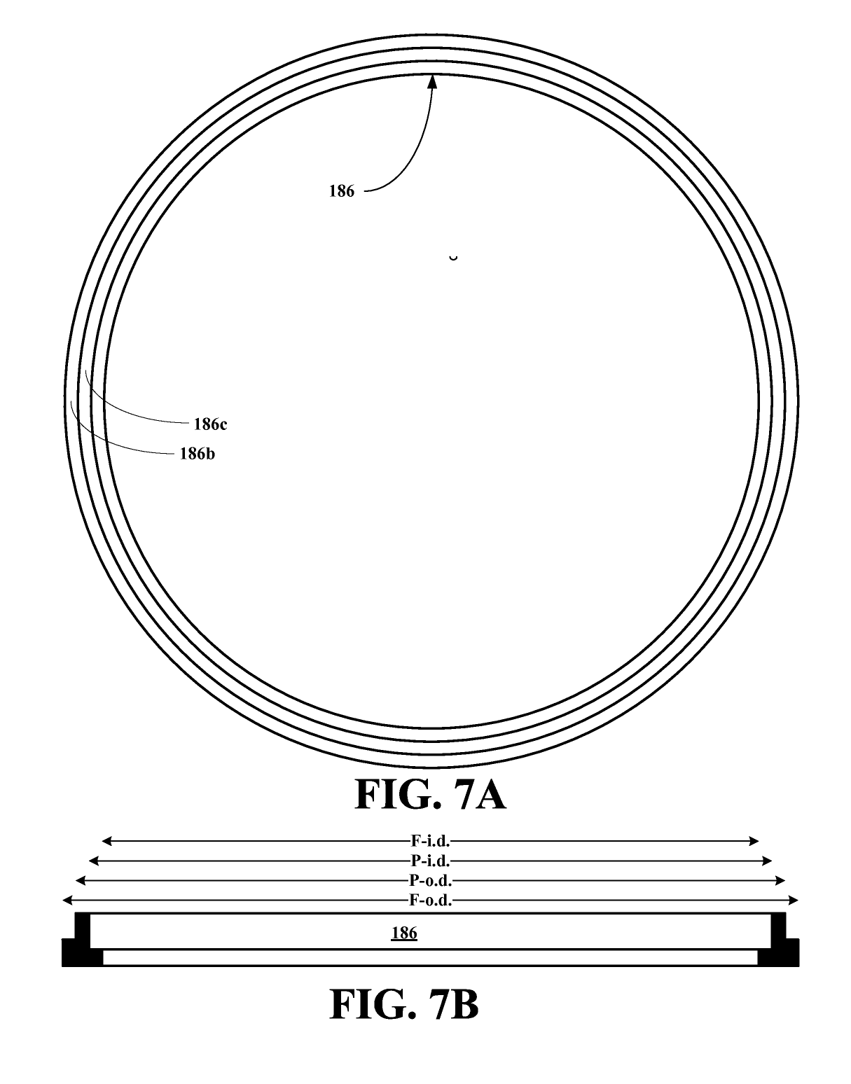

Referring now to FIGS. 7A&B, an embodiment of an L-shaped screen flange 186 having an outward extending part 186b shown plan and cross-sectional views. The flange 186 has a flange outer diameter F-o.d. and a flange inner diameter F-i.d. The flange 186 also includes a projecting member 186c having an outer diameter P-o.d. and an inner diameter P-i.d.

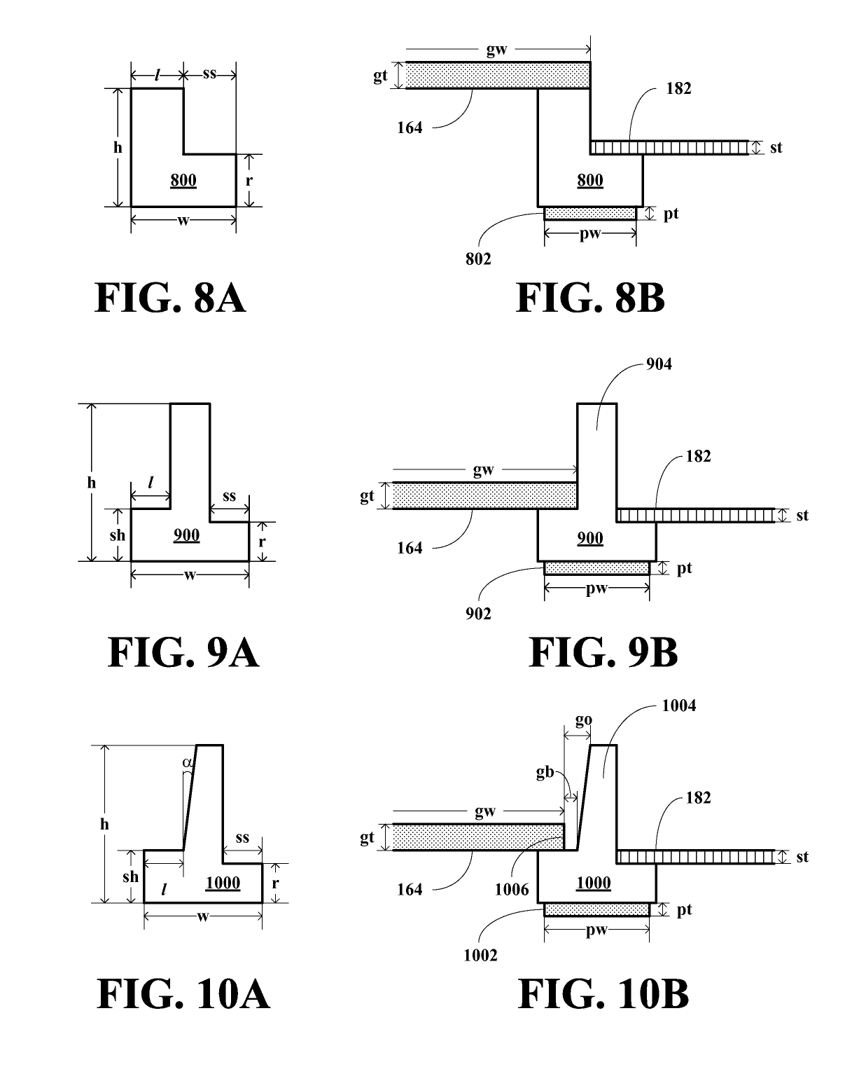

Referring now to FIG. 8A, a cross-section view of an illustrative embodiments of a first screen flange type 800 of this invention characterized by a flange height h, a flange width w, a gasket shoulder width l, a screen shoulder width ss, and a screen shoulder height r. The flange 800 is in the form of an L.

Referring now to FIG. 8B, a cross-section view of an expanded view of the flange 800 of FIG. 8A shown with the gasket 164, the screen 182, and an optional compressible component 802 adapted to be interposed between a bottom surface of the flange 800 and the end flange 112 of the reactor 100. The gasket 164 has a width gw and a thickness gt. The screen 182 has a thickness of st. Table I tabulates minimum and maximum guideline dimension for h, w, l, ss and r proportional to each other, the gasket width gw, the gasket thickness gt, and the screen thickness st.

TABLE I
Maximum and Minimum Guideline Dimensions
for the Screen Flange of FIG. 8A

| | h | w | r | ss | l |
|---|---|---|---|---|---|
| Maximums | 2.0 × w | 0.5 × gw | 2.0 × st | 4.0 × st | 4.0 × gt |
| Minimums | 1.0 × w | 0.25 × gw | 1.0 × st | 2.0 × st | 2.0 × gt |

The tabulated dimensions are guidelines. Actual dimensions of h, w, l, ss, and r may be successfully varied within and beyond these ranges depending on the reactor design by a person skilled in the art.

Referring now to FIG. 9A, a cross-section view of an illustrative embodiment of a second screen flange type 900 of this invention characterized by a flange height h, a flange width w, an axial retention face of width l, a screen shoulder width ss, a screen shoulder height r, and a gasket step height sh. The flange 900 includes a projecting member 904 and has the shape of an upside down T.

Referring now to FIG. 9B, a cross-section view of an expanded view of the flange 900 of FIG. 9A shown with the gasket 164, the screen 182, and an optional compressible component 902 adapted to be interposed between a bottom surface of the flange 900 and the end flange 112 of the reactor 100. The gasket 164 has a width gw and a thickness gt. The screen 182 has a thickness of st. Table II tabulates minimum and maximum guideline dimensions for h, w, l, ss, r, and sh in proportion to each other, the gasket width gw, the gasket thickness gt, and the screen thickness st.

TABLE II
Maximum and Minimum Guideline Dimensions
for the Screen Flange of FIG. 9A

| | h | w | sh | r | ss | l |
|---|---|---|---|---|---|---|
| Maximums | 3.0 × w | 0.5 × gw | 8.0 × gt | 2.0 × st | 4.0 × st | 4.0 × gt |
| Minimums | 1.0 × w | 0.25 × gw | 8.0 × gt | 1.0 × st | 2.0 × st | 2.0 × gt |

The tabulated dimensions are guidelines. Actual dimensions of h, w, l, ss, r, and sh may be successfully varied within and beyond these ranges depending on the reactor design by a person skilled in the art.

Referring now to FIG. 10A, a cross-section view of three illustrative embodiments of a first screen flange type 1000 of this invention characterized by a flange height h, a flange width w, a gasket interface length l, a screen shoulder width ss, a screen shoulder height r, a gasket step height sh, and an angle ? ? representing the projecting member 1004 departure from vertical and has the shape of an upside down T.

Referring now to FIG. 10B, a cross-section view of an expanded view of the flange 1000 of FIG. 10A shown with the gasket 164, the screen 182, and an optional compressible component 1002 adapted to be interposed between a bottom surface of the flange 1000 and the end flange 112 of the reactor 100. The gasket 164 has a width gw and a thickness gt. The gasket 164 is disposed on the flange 1000 so that a gap gb is formed between the gasket end 1006 and the angle projection 1004. The angled projecting member 1004 also defines a top gap go between the end 1006 of the gasket 164 and the angled projecting member 1004. The screen 182 has a thickness of st. Table III tabulates minimum and maximum relative values for h, w, l, ss, r, sh, gb, and go in terms of each other, the gasket width gw, the gasket thickness gt, and the screen thickness st.

TABLE III
Maximum and Minimum Guideline Dimensions for the Screen Flange of FIG. 10A

| | h | w | sh | r | ss | gb | go | l |
|---|---|---|---|---|---|---|---|---|
| Maximums | 3.0 × w | 0.5 × gw | 8.0 × gt | 2.0 × st | 4.0 × st | 4.0 × gt | gb + 4.0 × gt | 4.0 × gt |
| Minimums | 1.0 × w | 0.3 × gw | 8.0 × gt | 1.0 × st | 2.0 × st | 2.0 × gt | gb + 1.0 × gt | 2.0 × gt |

The tabulated dimensions are guidelines. Actual dimensions of h, w, l, ss, r, sh, gb, and go may be successfully varied within and beyond these ranges depending on the reactor design by a person skilled in the art.

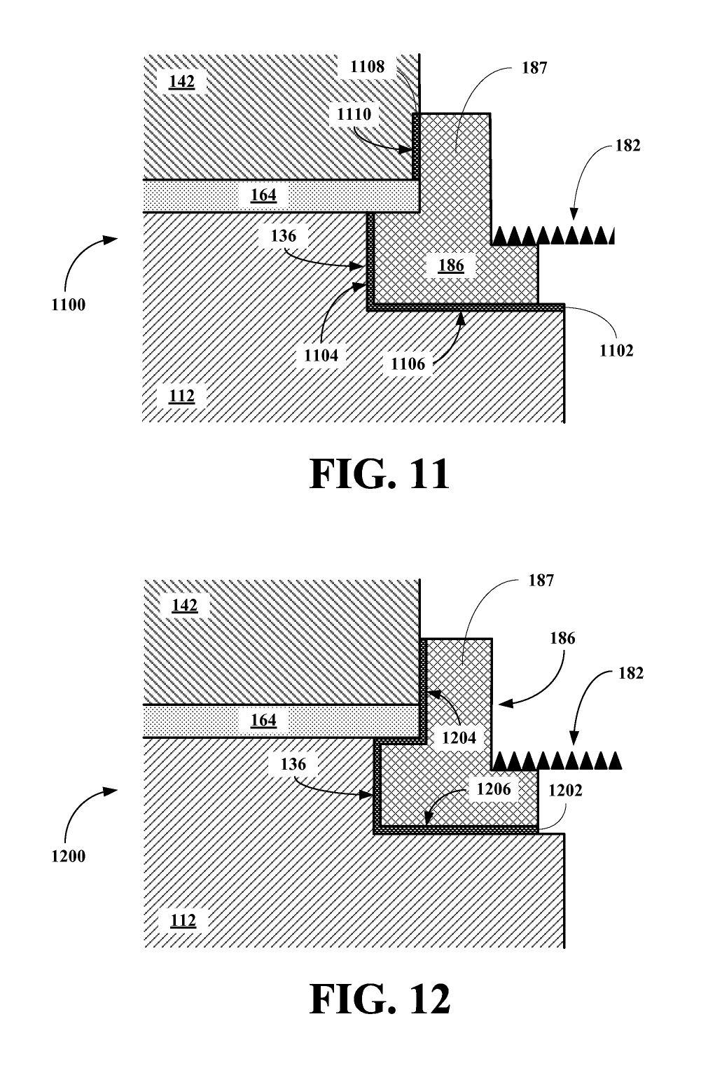

Referring now to FIG. 11, a cross-section view of an expanded portion of an assembled reactor, generally 1100, is shown to include a portion of the core flange 112 including the recess 136, the head flange 142, the gasket 164, the screen flange 186 having the projecting member 187, and the screen 182. The reactor 1100 is further shown to include a sacrificial surface coating or component 1102 disposed on screen flange contacting surfaces 1104 and 1106 of the core flange 112. The reactor 1100 is further shown to include a sacrificial coating or component 1108 disposed on a screen flange contacting surface 1110 of the head flange 142.

Referring now to FIG. 12, a cross-section view of an expanded portion of an assembled reactor, generally 1200, is shown to include a portion of the core flange 112 including the recess 136, the head flange 142, the gasket 164, the screen flange 186 having a projecting member 187, and the screen 182. The reactor 1200 is further shown to include a sacrificial surface coating or component 1202 disposed on an outer surface 1204 and a bottom surface 1206 of the screen flange 186.

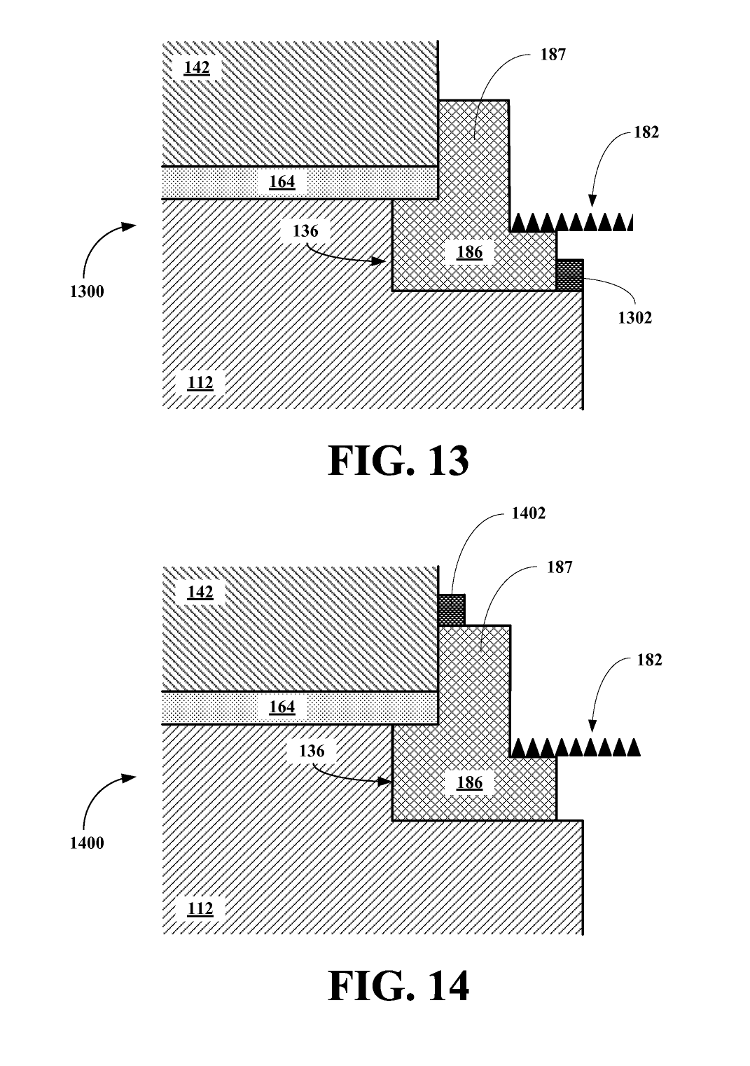

Referring now to FIG. 13, a cross-section view of an expanded portion of an assembled reactor, generally 1300, is shown to include a portion of the core flange 112 including the recess 136, the head flange 142, the gasket 164, the screen flange 186 having a projecting member 187, and the screen 182. The reactor 1300 is further shown to include a sacrificial surface component 1302 in the form of a ring disposed adjacent a bottom of the screen flange 186.

Referring now to FIG. 14, a cross-section view of an expanded portion of an assembled reactor, generally 1400, is shown to include a portion of the core flange 112 including the recess 136, the head flange 142, the gasket 164, the screen flange 186 having the projecting member 187, and the screen 182. The reactor 1400 is further shown to include a sacrificial surface component 1402 in the form of a ring disposed adjacent a top of the screen flange 186.

In all the screen flange embodiments disclosed above, the screen flanges may be inverted so that the recesses in the core flange and the head assembly flange are inverted and the screen flanges are designed to register with the inverted screen flange.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

We claim:

1. A reactor comprising:
a core including:
a plurality of reactor tubes, each tube having a first tube end and a second tube end,
a first core end flange and a second core end flange, each end flange including a core sealing surface,
a pattern of tube apertures disposed in each flange for locating the reactor tubes,
a core flange lip having apertures there through,
a gasket,
fasteners, and
a top head assembly and a bottom head assembly, each assembly including:
a head flange including an assembly sealing surface, a head flange lip having a plurality of apertures therethrough, and an optional head flange recess,
a cap section including an inlet port and an outlet port for flowing a reactant into and out of the reactor, and
an interior,
a top screen assembly and a bottom screen assembly, each screen assembly including:
a screen comprising a plurality of screen elements, and
a screen mounting flange characterized by an inside diameter, an outside diameter,
a projected minor diameter, an overall thickness, and a shoulder height, and
a core flange recess and/or a head flange recess adapted to receive the screen assembly, where:
the tubes are fixed in place within the tube apertures,
the screen is or the screen elements are affixed to the screen flange to form the screen assembly,
the gasket is interposed between the sealing surfaces,
the head assembly is seated on the core end flange so that the lip apertures of the core and the assembly are aligned and the fasteners are inserted through the lip apertures of the core and the assembly retains the gasket and screen assembly within and tightening the fasteners compresses the gasket creating a fluid tight seal between the core and the head assembly.

2. The reactor of claim 1, wherein the reactor may be operated in a down flow arrangement or an up flow arrangement simply by changing a reactant flow direction due to a top to bottom symmetry of the reactor.

3. The reactor of claim 1, wherein the reactor includes a core flange recess and a head flange recess.

4. The reactor of claim 1, wherein:
the screen flange outside diameter corresponds to and self locates within the screen flange recess of the core end flange,
the screen flange projected minor diameter corresponds to and self locates within the screen flange recess of the head assembly,
the gasket has an inside diameter corresponds to and self locates on the screen flange projected diameter,
a portion of the gasket material that extends inwardly beyond the sealing surface of the core end flange rests against the shoulder created by the radial difference between the screen flange outside and projected diameter, and
the portion of the gasket material that extends inwardly to rest against the screen flange axial retention face compresses when tightening the flange lip fasteners which presses the screen flange axially against the screen flange recess axial face thereby minimizing any gaps.

5. The reactor of claim 1, wherein the screen flange shoulder height corresponds to the depth of the screen flange recess of the core end flange.

6. The reactor of claim 1, wherein the screen assembly is seated within the head assembly screen flange recess.

7. The reactor of claim 1, wherein the gasket does not include a portion that extends past the sealing surface of core flange for pressing and holding the screen flange in axial contact, and further including a compressible component interposed between the screen flange and the core end flange.

8. The reactor of claim 1, wherein the screen assembly further includes:
ribs for reinforcing, and/or for mounting, and unmounting the screen or screen assembly.

9. The reactor of claim 8, wherein the ribs include holes, lugs, and/or flanges to assist screen handling.

10. The reactor of claim 1, wherein the screen assembly is partially or wholly retained by a dowel assembly.

11. The reactor of claim 1, further comprising:
top and bottom flow volumes are bounded between the screens and the tube ends and the ends of the core baffle, where the volumes are defined by a first gap height g between the screen flat ends and the tube ends and a second gap height r between the screen flat ends and the baffle tops, where the gaps g and r may be the same of different.

12. The reactor of claim 1, further comprising:
a catalyst loaded into the reactor in an amount sufficient to substantially fill the tubes and the flow volumes during normal reactor operation.

13. The reactor of claim 1, wherein each head assembly further includes:
flow baffle assembly mounted within the interior for distributing incoming reactant to the tubes of the reactor.

14. The reactor of claim 1, wherein the flow baffles include flow pathways therethrough.

15. The reactor of claim 1, further comprising:
a shell surrounding the tubes and including:
an interior, and
shell ports for circulating a heating or cooling fluid through the interior of the shell.

16. The reactor of claim 15, wherein the tubes have a geometrical cross-section and are arranged in a tube pattern having a packing efficiency within an geometrical shell, where tube cross-section and the envelop cross-section geometrical shapes are selected from the group consisting of circular, elliptical, polygonal, and mixtures thereof.

17. A method for forming a product comprising the steps of:
providing a top to bottom reversible flow reactor of claim 1,
loading a catalyst into the reactor in an amount sufficient to substantially fill the tubes and the flow volumes,
feeding a reactant stream into one of the ports of one of the head assemblies,
contacting the reactant with the catalyst in the tubes and the flow volumes, and
withdrawing a product stream through one of the ports of the other head assembly.

18. The method of claim 17, further comprising the steps of:
stopping the reactant flow, and
starting a flow of a reverse flow stream in an opposite flow direction to the reactant flow direction on an intermittent or periodic basis, where the reverse flow operates to clear the screens reducing maintenance.

19. The method of claim 18, further comprising the steps of:
regenerating the catalyst during reverse flow,
where the reverse flow stream is a catalyst regeneration stream and regeneration extends catalyst life.

20. The method of claim 17, further comprising the step of:
prior to the contacting step, distributing the reactant flow across the volumes and the tubes via a flow baffle to improve flow uniformity through the tubes.

21. A screen assembly comprising:
a screen comprising a plurality of screen elements, and
a screen mounting flange characterized by an inside diameter, an outside diameter, a projected minor diameter, an overall thickness, and a shoulder height, and
where the flange is adapted to conform to a core flange recess and/or a head flange recess, where the screen is or the screen elements are affixed to the screen flange to form the screen assembly or the screen assembly is of a unitary construction with the flange comprising the circumference of the screen, and where the screen includes openings small enough to minimize catalyst particle passage therethrough, while permitting reactant and product flow through the screen.
